(19) United States
(12) Patent Application Publication
(10) Pub. No.: US 2016/0139338 A1
(43) Pub. Date: May 19, 2016

(54) OPTICAL CONNECTOR HAVING WAVEGUIDE AND METHOD FOR MANUFACTURING SAME

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 14/245,044

(22) Filed: Apr. 4, 2014

(30) Foreign Application Priority Data
Apr. 12, 2013 (TW) 102112946

(51) Int. Cl. G02B 6/30; G02B 6/42; G02B 6/13

(52) U.S. Cl. CPC G02B 6/30; G02B 6/131; G02B 6/4243; G02B 6/4257

(57) ABSTRACT

An optical connector includes a semiconductor substrate, an epitaxial layer of photoelectric element, and a waveguide. The semiconductor substrate has a surface that includes a photoelectric element zone, a waveguide zone, and an optical fiber zone, and defines a receiving groove in the optical fiber zone extending through the optical fiber zone and connecting with the waveguide zone and configured for receiving an optical fiber. The epitaxial layer of photoelectric element is grown up from the photoelectric element zone. The waveguide is directly formed on the waveguide zone.

### BACKGROUND

1. Technical Field

The present disclosure relates to optical connectors and, particularly, to an optical connector having a waveguide and a method for manufacturing the same.

2. Description of Related Art

In optical communication, a photoelectric module, such as a light emitting diode or a photo diode, is packaged first by a semiconductor technique, and then is optically coupled with another photoelectric module by a waveguide. The photoelectric module and the waveguide are typically packaged as an optical connector. However, because of being packaged twice, the size of the optical connector is undesirably increased.

Therefore, it is desirable to provide an optical connector and a method for manufacturing the same that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIGS. 1-4 show how to perform a method for manufacturing an optical connector.

FIG. 5 shows another embodiment of the optical connector.

FIGS. 6-7 show an optical communication system constituted by the optical connectors of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the drawings.

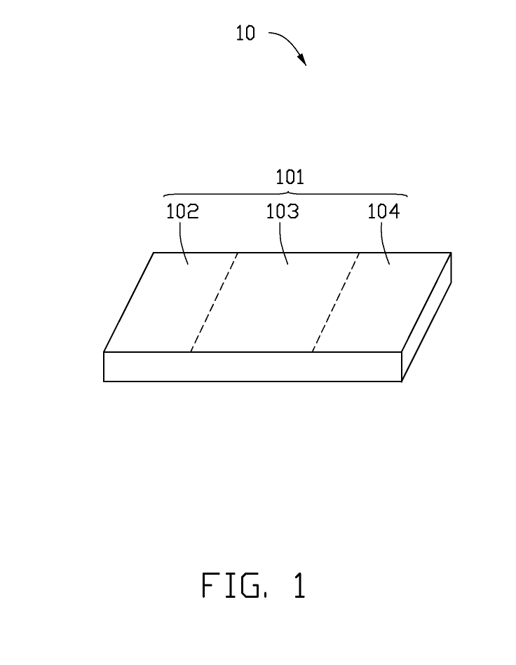

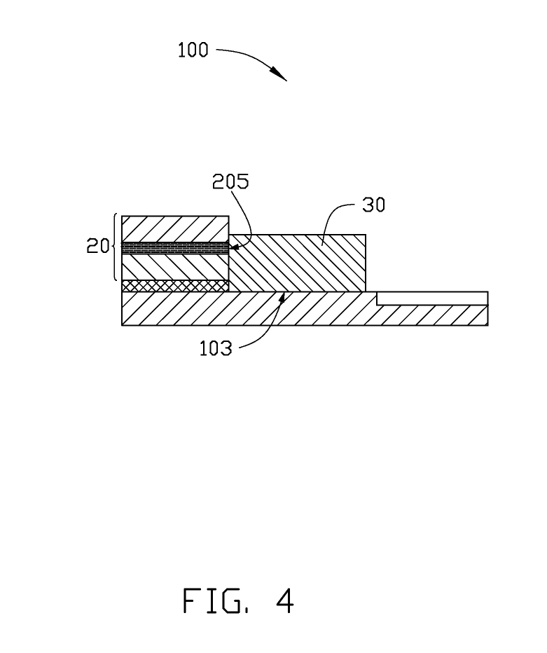

FIGS. 1-4 show how to perform a method for manufacturing an optical connector 100 (see FIG. 4).

As shown in FIG. 1, in the first step of the method, a semiconductor substrate 10 is provided. The semiconductor substrate 10 is substantially rectangular and includes a surface 101 which includes, in this order from a lengthwise side thereof to another, a photoelectric element zone 102, a waveguide zone 103, and an optical fiber zone 104.

However, the semiconductor substrate 10 is not limited to this embodiment but can take other forms in other embodiments depending on needs, for example, the semiconductor 10 is circular. The photoelectric zone 102, the waveguide zone 103, and the optical fiber zone 104 are not limited to this embodiment but can take other forms in other embodiments depending on needs, provided that the waveguide zone 103 is connected between the photoelectric zone 102 and the optical fiber zone 104.

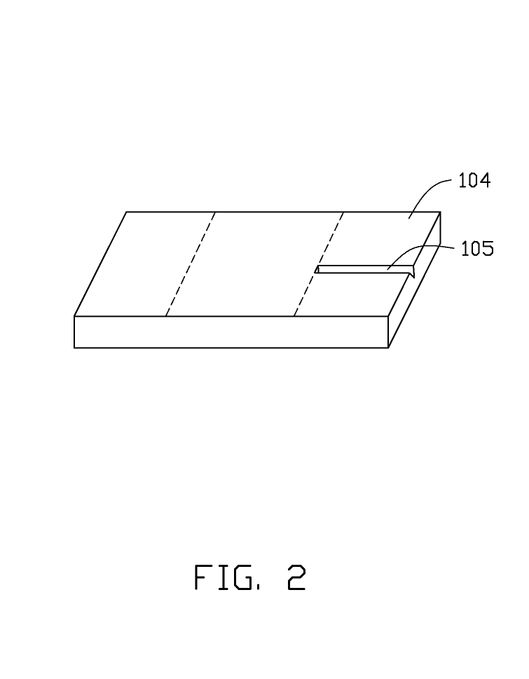

FIG. 2 shows that a receiving groove 105 is defined in the optical fiber zone 104 in the second step of the method. The receiving groove 105 extends through the optical fiber zone 104 along a lengthwise direction of the semiconductor substrate 10 and generally at a middle part in a widthwise direction of the semiconductor substrate 10. A cross-section of the receiving groove 105 is triangular.

The receiving groove 105 is not limited to this embodiment but can take other forms in other embodiments depending on need, for example, the receiving groove 105 extends through the optical fiber zone 104 and connects the waveguide zone 103 in any direction and has a cross-section in a shape other than triangular.

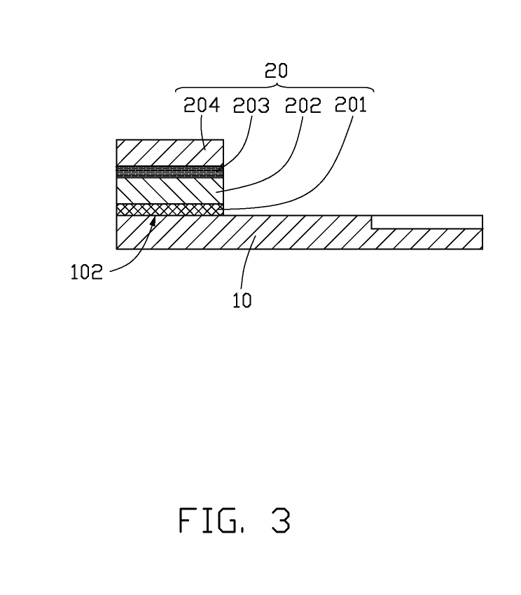

FIG. 3 shows that an epitaxial layer 20 of photoelectric element is grown up from the photoelectric zone 102 by, for example, a metal organic chemical vapor deposition (MOCVD) technique, in the third step of the method. In this embodiment, the photoelectric element is a laser diode (LD and the epitaxial layer 20 includes, in this order from the photoelectric zone 102, an N-type buffer layer 201, an N-type semiconductor layer 202, a multi-quantum-well (MQW) layer 203, and a P-type semiconductor layer 204. The P-type semiconductor layer 204 and the N-type semiconductor layer 202 constitute a PN junction and define an oscillating cavity therebetween. A light emitting surface (205 in FIG. 4) is formed on a side surface of the MQW layer 203 perpendicular to the surface 101 and adjacent to the waveguide zone 103.

In this embodiment, the N-type buffer layer 201, the N-type semiconductor layer 202, and the P-type semiconductor layer 204 can be but is not limited to be made of III-V group material. A material of the semiconductor substrate 10 is configured for growing an epitaxial layer 20 of laser light diodes (LDs) and can be but is not limited to be made of indium phosphide.

FIG. 4 shows that a waveguide 30 is formed on the waveguide zone 103 to form an LD epitaxial module 100 in the fourth step of the method. The waveguide 30, such as a film waveguide, connects with (i.e., contact) the epitaxial layer 20 and covers the light emitting surface 205.

The waveguide 30 can be doped with silicon dioxide and epitaxially grown from the waveguide zone 103. Alternatively, the waveguide 30 can be individually formed and adhered to the waveguide zone 103.

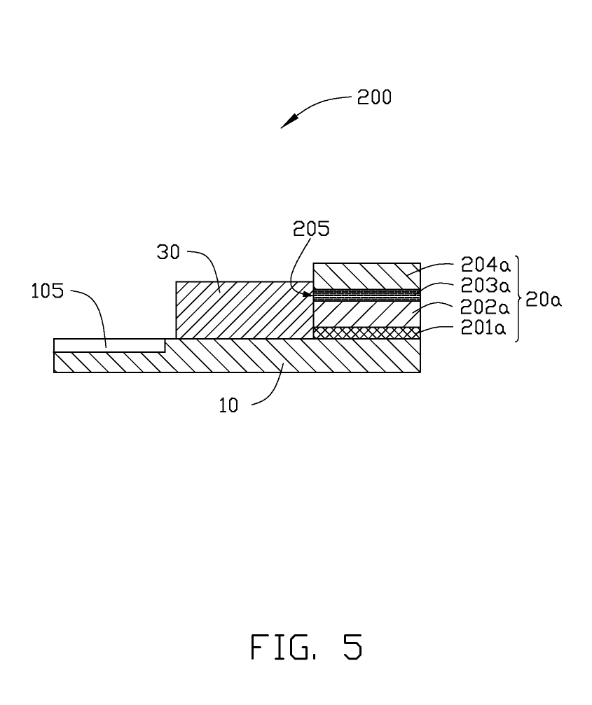

FIG. 5 shows another optical connector 200, which is essentially the same as the optical connector 100 except that the optical connector 200 includes an epitaxial layer 20a of photoelectric element in which the photoelectric element is a photo diode. The epitaxial layer 20a includes, in this order from the photoelectric element zone 102a P-type buffer layer 201a, a P-type semiconductor layer 202a, a MQW layer 203a, and an N-type semiconductor layer 204a. A light receiving surface 205a is formed on a side surface of the MQW layer 203a that is perpendicular to the photoelectric element zone 102 and adjacent to the waveguide zone 103.

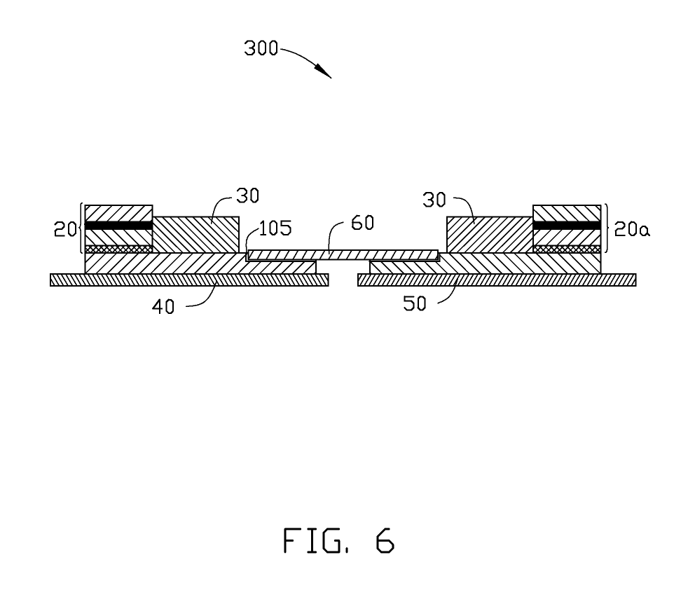

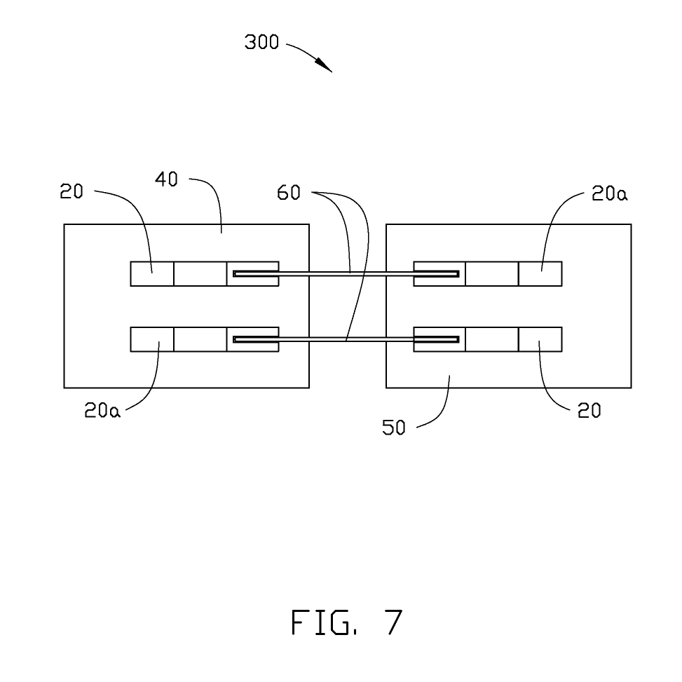

FIGS. 5-6 show that the optical connectors 100, 200 are in use. For example, an optical communication system 300 includes printed circuit boards 40, 50, each of which is mounted with the optical connectors 100, 200 and each optical connector 100 is coupled with one of the optical connectors 200 by an optical fiber 60 positioned in the receiving grooves 105 of the optical connectors 100, 200.

As the waveguide 30 is integrated with and can be packaged with the epitaxial layer 20 or 20a of photoelectric element, the optical connectors 100, 200 facilitate miniaturization.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A method for manufacturing an optical connector, the method comprising:
providing a semiconductor substrate having a surface that comprises a photoelectric element zone, a waveguide zone, and an optical fiber zone;
defining a receiving groove in the optical fiber zone extending through the optical fiber zone and connecting with the waveguide zone, the receiving groove being configured for receiving an optical fiber;
growing an epitaxial layer of photoelectric element up from the photoelectric element zone; and
forming a waveguide directly on the waveguide zone.

2. The method of claim 1, wherein the epitaxial layer comprises a multi-quantum-well (MQW) layer that comprises a light emitting or receiving side surface that contact with the waveguide.

3. The method of claim 1, wherein the waveguide is epitaxially grown up from the waveguide zone.

4. An optical connector, comprising:
a semiconductor substrate having a surface that comprises a photoelectric element zone, a waveguide zone, and an optical fiber zone, the semiconductor substrate defining a receiving groove in the optical fiber zone extending through the optical fiber zone and connecting with the waveguide zone, the receiving groove being configured for receiving an optical fiber;
an epitaxial layer of photoelectric element grown up from the photoelectric element zone; and
a waveguide directly formed on the waveguide zone.

5. The optical connector of claim 4, wherein the epitaxial layer comprises a multi-quantum-well (MQW) layer that comprises a light emitting or receiving side surface that contact with the waveguide.

6. The optical connector of claim 4, wherein the waveguide is epitaxially grown up from the waveguide zone.
